(19) United States
(12) Patent Application Publication
(10) Pub. No.: US 2011/0047200 A1
(43) Pub. Date: Feb. 24, 2011

(54) A METHOD AND A SYSTEM FOR VALIDATING A SUCCESSION OF EVENTS EXPERIENCED BY A DEVICE

(75) Inventor: Nicolas Reffe, Montpellier (FR)

Correspondence Address: FITCH, EVEN, TABIN & FLANNERY, P. O. BOX 18415, WASHINGTON, DC, 20036, US

(73) Assignee: ORIDAO, Montpellier CEDEX 2 (FR)

(21) Appl. No.: 12/990,189

(22) PCT Filed: Jun. 22, 2009
(86) PCT No.: PCT/FR09/51188

§ 371 Date: Oct. 28, 2010

(30) Foreign Application Priority Data
Jun. 27, 2008 (FR) 0854339

(51) Int. Cl. G06F 17/40; G06F 17/15

(52) U.S. Cl. 708/422; 702/187

(57) ABSTRACT

The invention relates to a method of validating a succession of events in the life of a device (10) relative to a predefined succession of events, including the following steps: for each event of the succession: calculating a current value of a traceability mark by applying to an identifier of the event a cryptographic hashing function with parameters set by the preceding value of the traceability mark; storing this current value on the device; after the succession of events, a checking system obtaining the latest value of the traceability mark stored on the device; this system generating the value of a theoretical mark by applying the hashing function successively to identifiers taken in the order of the events of the predefined succession; and if the latest value of the traceability mark is equal to the theoretical mark, validating that the predefined succession of events has been experienced by the device.

### BACKGROUND OF THE INVENTION

The present invention relates to the general field of traceability devices of any kind, such as materials, products, or objects, for example.

It relates more particularly to mechanisms making it possible to verify at any stage of a process comprising a plurality of events whether a device that has reached this stage has undergone or experienced all of the events of the process in a predetermined order.

In the context of the invention, an event experienced by a device may in particular be a treatment applied to the device or a state or a change of state of a physical parameter of the device (for example its temperature, its pressure, etc.).

In the current state of the art, there exist traceability mechanisms for tracking all events of a process experienced by a device (for example the steps of fabrication, transformation, and distribution of a device). These mechanisms rely on reading tracking data at predefined points of passage associated with the various events of the process and on storing it on paper or digital media, which tracking data may be an identifier of the device (for example after reading a bar code or a radiofrequency identity (RFID) label).

To determine whether a device has undergone all of the planned events at a particular stage of the process, it is possible to connect those points of passage to a centralized information system in order to send it the stored data and thereafter to consult the information system.

However, that solution is highly complex in terms of deployment and has a high implementation cost, especially with distribution network traceability applications in which the various points of passage are not in the same place (e.g. points of passage at different subcontractors or in different distribution networks).

It further requires means for connecting to the remote interrogation and centralized information system.

What is more, that solution entails high redeployment costs and delays in the event of any variation in the tracked process.

Another alternative is to use storage media on the devices, for example RFID labels, incorporating memory modules of appropriate size for individually storing tracking data associated with each event experienced by each device.

That alternative has the advantage that the tracking data for determining whether a device has undergone all the planned events is carried by the device itself and therefore simple and quick to use.

However, because of the size of the memory modules to be incorporated to validate a succession of events, the cost of the storage media used is very high.

Furthermore, such storage media and in particular RFID labels are easy to read and the data that they carry is in no way confidential.

There is therefore a requirement for a technical solution that is simple to deploy and of relatively low cost, at the same time as being secure and of compact overall size, making it possible to determine whether at any particular stage of a process a device has undergone all of the planned events of that process in order.

### OBJECT AND SUMMARY OF THE INVENTION

A first aspect of the present invention provides a method of validating a succession of events in the life of a device relative to a predefined succession of events, said method including:
for each event of the succession experienced by the device:
   a step of calculating a current value of a traceability mark by applying to an identifier of the event a cryptographic hashing function with parameters set by the value of the traceability mark calculated for the preceding event;
   a step of storing this current value on the device;
   after the succession of events, a step of a checking system obtaining the latest value of the traceability mark stored on the device;
   a step of this checking system generating the value of a theoretical mark by applying the hashing function successively to identifiers taken in the order of the events of the predefined succession; and
   if the latest value of the traceability mark is equal to the value of the theoretical mark, a step of validating that the predefined succession of events has been experienced by the device.

In a correlated way, the invention also provides a system for validating a succession of events in the life of a device relative to a predefined succession of events, said system including:
means for obtaining an identifier of each event of the succession;
calculation means for calculating for each event of the succession a current value of a traceability mark by applying to the identifier of the event a cryptographic hashing function with parameters set by the value of the traceability mark calculated for the preceding event;
storage means for storing this current value on the device;
a checking system including:
   means for obtaining the latest value of the traceability mark stored on the device after the succession of events;
   means for generating a value of a theoretical mark by applying the hashing function successively to identifiers taken in the order of the events of the predefined succession; and
   means for validating that the predefined succession of events has been experienced by the device if the latest value of the traceability mark is equal to the value of the theoretical mark.

Thus, in accordance with the invention, validation is effected in two stages:
a first stage of marking the device with a digital traceability mark calculated using a cryptographic hashing function and representing a succession of events experienced by the device; and
a second stage of checking the traceability mark by comparing it with a theoretical mark generated using the same cryptographic hashing function and representing an expected succession of events of the process.

Of course, the event identifiers used during the marking stage and during the checking stage must be mutually consistent, i.e. identical if they identify the same event.

Generally speaking, a cryptographic hashing function (or cryptographic hashing algorithm) submits an input data message of any size to a process or to a succession of processes to produce a digital mark of fixed size to identify the input data.

Such a function generally has the following properties:
it is very difficult to retrieve the content of the message from the digital mark;
it is very difficult to generate from a given message and its digital mark another message that gives the same digital mark; and
it is very difficult to find two random messages that give the same digital mark (this is referred to as collision resistance).

By “very difficult” here is meant technically impossible in practice, i.e. in a reasonable time, using any algorithmic technique and/or hardware.

Because it has such properties, a cryptographic hashing function is conventionally used in cryptography in protocols for authenticating or checking the integrity of documents.

The invention proposes to use this function in a traceability context and at any stage (intermediate or final stage) of a given process to validate that a device has complied with a finite chain of events of that process in a given order, but without storing on the device tracking data other than a digital traceability mark that is of fixed size regardless of the number of events concerned.

The digital traceability mark generated for each event inherently includes a summary of the preceding events experienced by the device. Consequently, it is not necessary, for each event experienced by the device, to store a digital mark specific to that event. Only the digital mark generated for the latest event experienced by the device is used for validation.

Thus the invention enables a substantial saving in terms of overall size compared to the solutions proposed in the prior art. As a result, the use of passive RFID chips with very small storage space allows the traceability mark to be stored on the device, which represents a non-negligible improvement in cost terms for a company seeking to make its products traceable.

The invention also proposes a solution that is secure and reliable. Given the properties of the cryptographic hashing function, it is impossible, if the traceability mark differs from the expected theoretical mark, to establish a simulated succession of events to return the traceability mark to the expected value.

Moreover, since a cryptographic hashing function is a one-way function, a mark may be calculated knowing the succession of events experienced by the device, but it is impossible to deduce those successive events knowing only the mark. Consequently, reading the traceability mark of a device at any stage of a process does not enable a malicious person to deduce even the slightest amount of information as to the process itself and in particular as to the string of events of the process.

Moreover, subject to knowing the initial traceability mark, the theoretical mark (i.e. the mark expected given the predefined succession of events) may be calculated separately from the device and subsequently compared to the traceability mark carried by the device. This limits redeployment costs in the event of modifying the process, the traceability mark being calculated in a similar way whatever the complexity and length of the process and it being possible to calculate the theoretical mark for a predefined succession of events beforehand, independently of the device.

In one particular embodiment of the invention, the means for obtaining an identifier of each event from the succession of events, the means for calculating the traceability mark (including the means for applying the cryptographic hashing function), and the storage means are on the device. They are for example implemented in an active or passive RFID chip carried by or integrated into the device.

As a result of this, it is not possible to modify the value of the traceability mark before storing it on the device.

Alternatively, the means for obtaining an identifier and the means for calculating the traceability mark may be implemented in a calculation module that is not carried by the device. This solution requires recovery by the calculation module of the value of the digital traceability mark calculated for the preceding event.

This reduces the hardware complexity required of the device for implementing the invention. However, this solution is preferably used for tracing a device in a monitored internal process with no risk of misappropriation (interception and modification of the traceability mark between the calculation module and the device) or is accompanied by making the connection between the calculation module and the device secure.

The traceability mark may be stored on the device on various kinds of medium carried by or integrated into the device, for example a rewritable digital memory, an active or passive RFID chip or label, etc. Using a passive RFID label or chip has the advantage of relatively low cost.

The identifier of each event from the succession of events may be predefined. It is specific to the event, for example an event number, etc. It is preferably managed by a module external to the tracked device and associated with the event concerned, which sends the device or the calculation module the identifier of the event experienced by the device before the calculation step.

In another implementation of the invention, the validation method further includes, for each event, before the calculation step:
a step of a module associated with the event obtaining the value of the traceability mark calculated for the preceding event; and
a step of said module calculating the identifier of this event by applying to an initial identifier of this event a second hashing function with parameters set by this value.

In a correlated way, the validation system may further include a module associated with each event of the succession and including:
means for obtaining from the device the value of the traceability mark calculated for the preceding event; and
calculation means for calculating the identifier of this event by applying to an initial identifier of this event a second cryptographic hashing function with parameters set by this value.

In this variant, a so-called “reciprocal ignorance” protocol is used between the module associated with each event and the entity responsible for calculating the digital traceability mark (an external calculation module or the device itself).

The module associated with each event receives the digital traceability mark but cannot access events previously experienced by the device simply by reading the mark.

Similarly, the external calculation module or the device itself receives the event identifier transmitted by the module associated with the event and used to generate the traceability mark but cannot access the initial identifier of the event in progress simply by reading this event identifier.

In one embodiment of the invention, the storage means store the current value of the traceability mark on the device by replacing the value of the traceability mark stored for the preceding event.

Alternatively, all the digital mark values may be stored (for example in order to be able, retroactively during an investigation stage, to retrieve an event from the predefined succession that might not have been experienced by the device), but the method of the invention uses only the latest value of the digital traceability mark.

The invention therefore relies on the following entities:
the tracked device, which stores in the traceability mark a history of the events that it has experienced at a given stage of a process;
a calculation module, which may be integrated into the device and that calculates for each event the current value of the traceability mark using a hashing function; and
the checking system, which is adapted to evaluate a theoretical mark relative to a predefined succession of events and to check that this succession of events has been experienced by the device.

Thus the invention also provides these three entities.

A second aspect of the invention provides a method of checking whether a predefined succession of treatments of events has been experienced by a device, including:
a step of obtaining a value of a traceability mark stored on the device;
a step of generating a value of a theoretical mark by applying a cryptographic hashing function successively to identifiers taken in order of the events of the predefined succession; and
a step of validating that said predefined succession of events has been experienced by the device if the value of the traceability mark is equal to the value of the theoretical mark.

In a correlated way, the invention also provides a system for checking whether a predefined succession of treatments of events has been experienced by a device, the system being characterized in that it includes:
means for obtaining a value of a traceability mark stored on the device;
means for generating a value of a theoretical mark by applying a cryptographic hashing function successively to identifiers taken in order of the events of the predefined succession;
means for comparing the value of the traceability mark with the value of the theoretical mark; and
means for determining that the predefined succession of events has been experienced by the device if the value of the traceability mark is equal to the value of the theoretical mark.

A third aspect of the invention provides a method of marking a device, the method being characterized in that it includes, for each event of a succession of events experienced by the device:
a step of obtaining an identifier of this event;
a step of calculating a current value of a traceability mark by applying to the identifier of this event a cryptographic hashing function with parameters set by the value of the traceability mark calculated for the preceding event; and
a step of storing this current value on the device.

In a correlated way the invention also provides a device including:
identifier-obtaining means for obtaining an identifier of each event of a succession of events in the life of the device;
calculation means for calculating for each event of the succession a current value of a traceability mark by applying to the identifier of the event a cryptographic hashing function with parameters set by the value of the traceability mark calculated for a preceding event; and
storage means for storing this current value.

In one embodiment the obtaining, calculation and, storage means are implemented in an RFID chip on or integrated into the device.

The device of one particular embodiment of the invention further includes:
means for receiving a proprietor code; and
means for protecting this code adapted to render it inaccessible to an unauthorized third party by interrogating said chip; and
the calculation means are further adapted to calculate an initial value of the traceability mark by applying the hashing function to at least this proprietor code.

In this way, the traceability marks calculated by the device cannot be counterfeited by an unauthorized person external to the validation application.

The device of one particular embodiment of the invention further includes means for activating and deactivating the above-mentioned obtaining, calculating, and storing means.

In one particularly advantageous variant of the invention the RFID chip concerned is a passive RFID chip.

Thus the invention further provides an RFID chip adapted to be mounted on a device and including:
means for obtaining an identifier of each event of a succession of events in the life of the device;
calculation means for calculating for each event of the succession a current value of a traceability mark by applying to the identifier of the event a cryptographic hashing function with parameters set by the value of the traceability mark calculated for a preceding event; and
storage means for storing this current value.

The RFID chip of one particular embodiment of the invention further includes:
means for receiving a proprietor code; and
means for protecting this code adapted to render it inaccessible to an unauthorized third party by interrogating the chip; and

is such that the calculation means are further adapted to calculate an initial value of the traceability mark by applying said hashing function to at least this proprietor code.

As a result, as described above, the traceability marks calculated by the RFID chip cannot be counterfeited by an unauthorized person external to the validation application.

The proprietor code is for example an identifier specific to the user seeking to effect the validation.

The means for protecting the proprietor code employed may be of various kinds.

For example, on reception of this proprietor code, the device of the invention may store this code in a volatile memory for calculating the cryptographic hashing function so that after the initial mark has been calculated, the value of the proprietor code is not kept. It is standard practice for the processing variables used by cryptographic hashing functions not to be kept (they are usually deleted after each use or overwritten by other processing variables).

Alternatively, on reception of the proprietor code, the device of the invention may store it in a secure memory, for example a memory protected by an encryption or authentication algorithm, so that only an authorized person (e.g. a person holding the appropriate decryption key) can access the code.

Note that the checking system must know this code to effect validation.

In one particular embodiment, the steps of the checking method are determined by computer program instructions.

Consequently, the invention also provides a computer program on an information medium, which program may be executed in a checking system or more generally in a computer, the program including instructions adapted to execute the steps of a checking method as described above.

This program may use any programming language and take the form of source code, object code, or a code intermediate between source code and object code, such as a partially-compiled form or any other desirable form.

The invention also provides a computer-readable information medium containing the above computer program instructions.

The information medium may be any entity or device capable of storing the program. For example, the medium may include storage means, such as a read-only memory (ROM), for example a compact disk (CD) ROM or a micro-electronic circuit ROM, or magnetic storage means, for example a floppy disk or a hard disk.

Moreover, the information medium may be a transmissible medium such as an electrical or optical signal, which may be routed via an electrical or optical cable, by radio or by other means. The program of the invention may in particular be downloaded over an Internet-type network.

Alternatively, the information medium may be an integrated circuit in which the program is incorporated, the circuit being adapted to execute the method in question or to be used in its execution.

### BRIEF DESCRIPTION OF THE DRAWINGS

Other features and advantages of the present invention emerge from the following description with reference to the appended drawings, which show non-limiting embodiments of the invention. In the figures:

FIG. 1 represents a device of the invention in its environment in a validation system of a first embodiment of the invention;

FIG. 2 represents diagrammatically an RFID label associated with the device of one particular embodiment of the invention;

FIG. 3 represents in flowchart form the main steps of a marking method of one particular implementation of the invention when executed by a device as represented in FIG. 1;

FIG. 4 represents a checking system of one particular embodiment of the invention in its environment;

FIG. 5 represents in flowchart form the main steps of a checking method of one particular implementation of the invention when executed by a checking system as represented in FIG. 4;

FIG. 6 represents an example of digital marks generated during the marking method and the checking method of the invention;

FIG. 7 represents a device of the invention in its environment in a validation system of a second embodiment of the invention;

FIG. 8 represents one example of a hashing function that may be used in a device and/or an RFID chip and/or a checking system of the invention; and

FIG. 9 represents one particular implementation of a hashing function as represented in FIG. 8.

### DETAILED DESCRIPTION OF EMBODIMENTS OF THE INVENTION

The embodiments of the invention described here relate to tracking any device (such as an object, a material, or a product) that is subjected to a succession of treatments of a process in order to validate that succession of treatments relative to an expected predefined succession of treatments.

This application is not limiting on the invention, however. The invention may equally be applied to tracking any events in the life of a device, for example evolution of the state of physical parameters of the device, for example in a sterilization process or a cooling system.

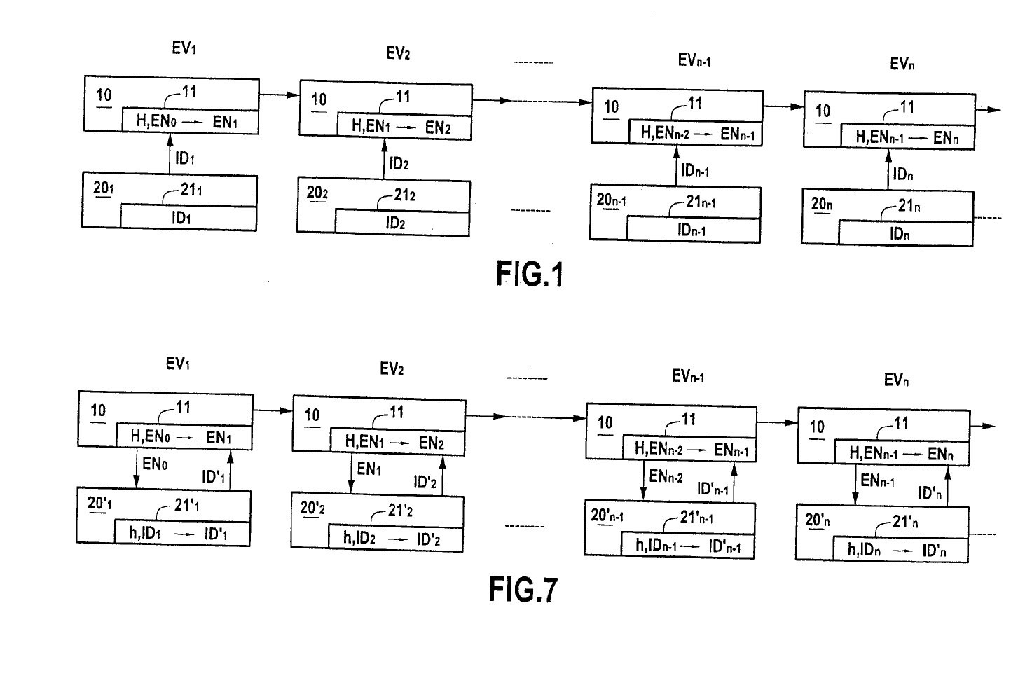

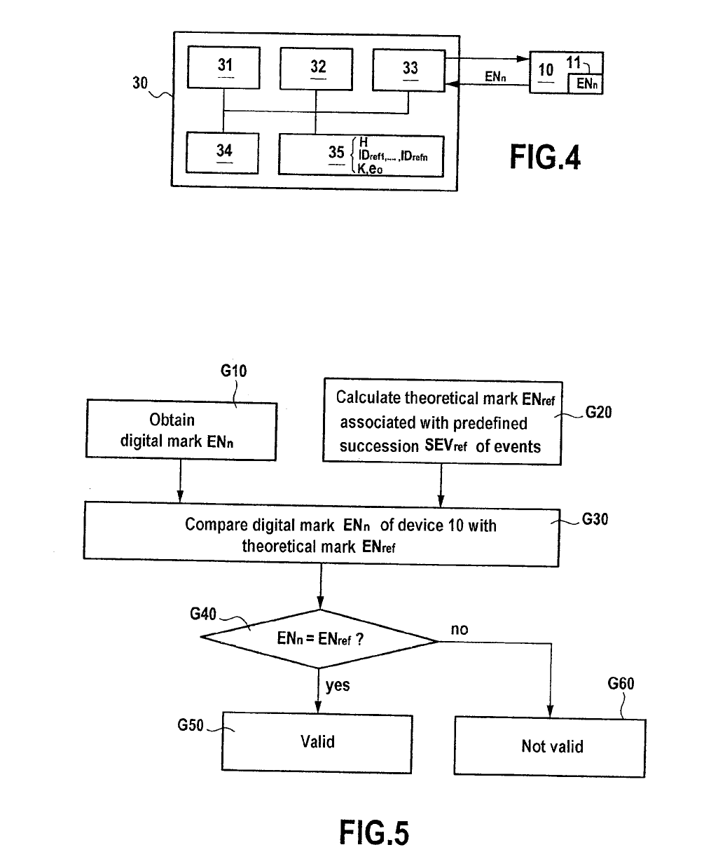

As mentioned above, validation in accordance with the invention comprises two stages:
a stage of marking the device, with the aim of calculating a traceability mark representative of a succession of events in the life of the device and implemented in two implementations of a marking method of the invention described below with reference to FIGS. 1, 2, 3, and 7; and
a checking stage, consisting in “interpreting” this traceability mark by comparing it with a theoretical mark representative of an expected theoretical succession of events from the life of the device. This checking stage is implemented by a checking method of the invention described below in one implementation with reference to FIGS. 4, 5, and 6 in particular.

FIG. 1 represents a device 10 of the invention in its environment in a validation system of a first embodiment of the invention. The device 10 is a calculation device in the sense in which this term is to be understood in the context of the invention.

It is assumed here that there is applied to this device 10 a process PROC comprising a number M of successive treatments EV₁, EV₂, . . . , EVₙ, EV_{M}. Here validation of the succession SEV of n consecutive events EV₁, EV₂, . . . , EVₙ is envisaged. Alternatively, other successions of events may be envisaged (for example a succession of non-consecutive but ordered events such as the succession consisting of the events EV₂, EV₄, EV_{M}).

In the embodiment of the invention described here, the device 10 incorporates (or carries) an RFID electronic label 11. This label may be active or passive.

In the context of the invention, the RFID electronic label 11 is considered to form part of the device 10 and in particular it is considered that data stored on the RFID label 11 is “on” the device 10, even if this entails a somewhat strained interpretation of the language employed.

The structure and the general operating principles of passive or active RFID labels are known to the person skilled in the art and are not described in more detail here.

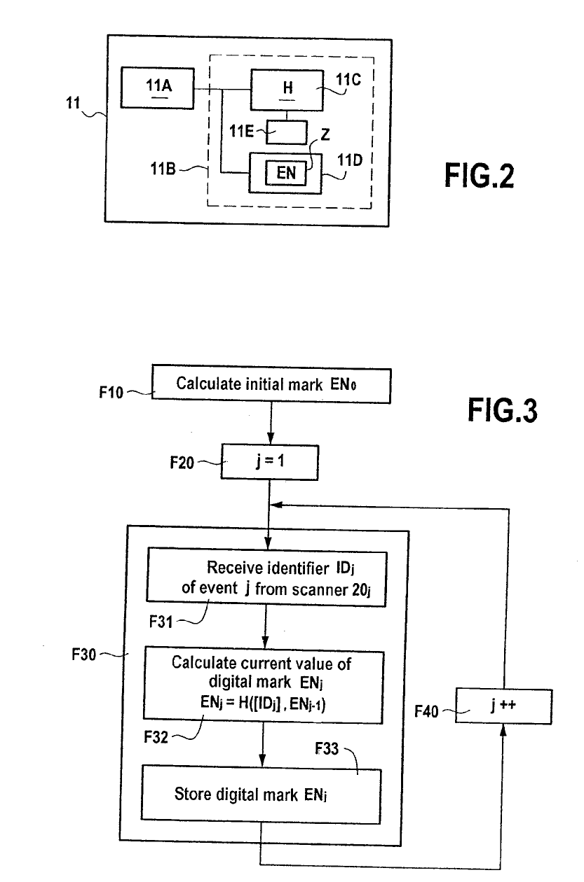

FIG. 2 illustrates diagrammatically one example of such a label. It includes in particular an antenna 11A connected to an RFID chip 11B.

The antenna 11A of the RFID label 11 is adapted to transmit and receive radio waves, for example from a read/write system such as an RFID reader or scanner.

In the example envisaged here, one such scanner 20ⱼ is associated with each treatment EVⱼ for j=1, . . . , M. Each scanner 20ⱼ stores in a memory 21ⱼ an identifier IDⱼ specific to the treatment EVⱼ (the identifier of the event EVⱼ in the sense of the invention). The identifier IDⱼ is stored in the form of a block of digital (for example binary) data of size that is a multiple of a predetermined value p.

The size of a block of digital elements (e.g. a block of binary data) is the number of elements (e.g. bits) of that block.

The identifiers IDⱼ may be different sizes.

Alternatively, and in particular if the various treatments applied to the device 10 are co-located, using the same read/write system for the various treatments applied to the device may be envisaged, the system storing an identifier specific to each treatment.

The chip 11B of the RFID label here includes calculation means 11C implementing a cryptographic hashing function H associated here with the treatment process PROC. This function H is for example one of the following known cryptographic hashing functions: SHA-1 (Secure Hash Algorithm-1), SHA-2 (Secure Hash Algorithm-2) or MD5 (Message Digest 5).

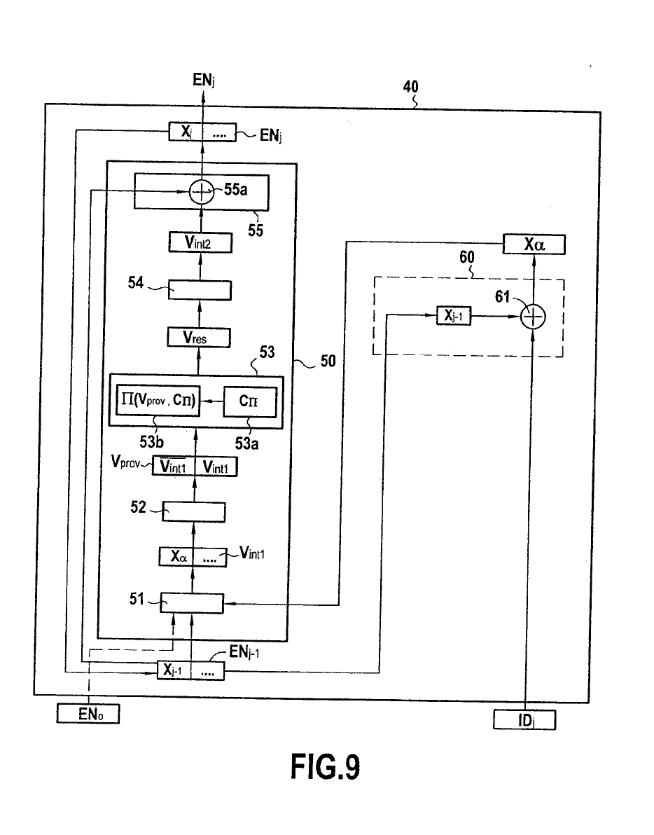

Alternately, some other hashing function may be used. An example of such a function is described below with reference to FIGS. 8 and 9.

As is known in the art, a cryptographic hashing function subjects data to a treatment or a plurality of successive treatments to generate a digital mark of given fixed size from an initial mark value. Thus it is assumed here that the hashing function H is adapted to “hash” successively blocks of digital data U₁, U₂, etc. of size p to calculate a digital mark E of size t from an initial mark value Eᵢₙᵢₜ.

The following notation:

E=H([U₁,U₂, . . . , U_{q}],Eᵢₙᵢₜ)=H([U],Eᵢₙᵢₜ)

is used below to designate the mark E obtained from the mark Eᵢₙᵢₜ by successively hashing q blocks U₁, U₂, . . . , U_{q} of size p. In the sense of the invention, the digital mark E is the result of applying to the data U₁, U₂, . . . , U_{q} the hashing function H with parameters set by Eᵢₙᵢₜ.

In the examples described, it is generally considered that the data blocks to which the cryptographic hashing functions are applied have sizes that are multiples of p so that these functions successively hash blocks of fixed size p. However, this assumption is not limiting on the invention, and it is possible, for example, to consider blocks of any size by using either padding techniques known to the person skilled in the art to obtain blocks with a size that is a multiple of p or appropriate hashing functions adapted to hash blocks of varying size.

In another embodiment of the invention, the calculation means of the function H may be implemented in a calculation module external to the device 10 and adapted to communicate with the device 10 and in particular with the RFID label. An external calculation module of this kind may in particular be implemented for each event EVⱼ in the scanners 20ⱼ described above.

The chip 11B of the RFID label 11 further includes means 11D for storing a digital mark of size t that include in particular a rewritable area Z of size t.

Alternatively, instead of being rewritable, this area Z may be adapted to contain consecutive stored digital marks.

Described below with reference to FIG. 3 are the main steps of the marking method of the invention when implemented by the device 10 of one particular embodiment of the invention represented in FIG. 1.

As mentioned above, marking consists in calculating what is called a traceability mark representing the ordered succession of treatments EV₁, EV₂, . . . , EVₙ applied to the device 10 and storing it on the device 10. To this end, a digital mark EN stored on the RFID label 11 is updated as the various treatments are applied to the device 10.

Before the device 10 actually starts the marking method, the RFID label 11 calculates an initial value EN₀ of the traceability mark EN using the hashing function H (step F10).

It uses for this purpose:
a public mark e₀ of size t, for example common to all the devices tracked using a marking method and a validation method of the invention; and
a proprietor code K, for example specific to the user A seeking to validate the succession of treatments EV₁, EV₂, . . . , EVₙ applied to the device 10 by means of the validation method of the invention; here this proprietor code K has a size that is a multiple of p.

The public mark e₀ is stored beforehand in the RFID label 11, for example by the manufacturer of the RFID label.

The proprietor code, for its part, is transmitted to the RFID label in a secure environment, for example when associating the RFID label 11 with the device 10. It is stored in the RFID label 11 directly (and here only) in a calculation volatile memory 11E for the function H for as long as it is in use for calculating the value of the initial mark. The volatile memory 11E is for example a calculation register for the function H.

In the example described here, the RFID label 11 calculates the initial mark EN₀ by applying the hashing function H with parameters set by the public mark e₀ to the proprietor code K, i.e.:

EN₀=H([K],e₀)

According to the invention, the variables to which the cryptographic hashing function H is applied (e.g. the event identifiers and the proprietor code) generally pass in transit through a calculation volatile memory for this function (such as the above-mentioned memory 11E) but do not remain in that memory after the hashing function is applied. They are deleted from this memory or overwritten by other processing variables of the function H, for example.

Accordingly, as soon as it has been used to calculate the initial mark EN₀, the proprietor code K is deleted from the volatile memory 11E. Thus an unauthorized third party cannot access the proprietor code from the device 10, in particular by reading the RFID chip 11. As a result, the traceability marks generated afterwards cannot be counterfeited.

The RFID chip obtaining the proprietor code K in a secure environment, storing this proprietor code in a calculation volatile memory for the function H, and the function H not keeping the processing variables used all represent means for protecting the proprietor code in the sense of the invention.

Alternatively, other protection means may be used by the RFID chip to render the proprietor code inaccessible. For example, the proprietor code may be stored in a memory made secure by a cryptographic encryption or authentication process.

It is to be noted that the initial digital mark EN₀ may be obtained as a function of the size of the proprietor code K in one or more iterations, in a manner known to the person skilled in the art. For example, if the proprietor code K is of size 3*p and consists of three blocks of data k₁, k₂, k₃ (K=[k₁, k₂, k₃]) each of size p, the digital mark EN₀ is obtained in three successive iterations each corresponding to the function H hashing one block kᵢ (for i=1, 2, 3). Below, this applies equally to any calculation involving a hashing function.

Moreover, the proprietor code K may advantageously be divided into blocks of size p by the entity that transmits this proprietor code to the RFID label, which entity then transmits each block of size p in succession to the RFID label.

In another embodiment, it is possible to use other identifiers to generate the initial mark, for example:
an identifier of the device 10 (serial number or batch number of the device, range of products to which the device belongs, etc.), either stored on the RFID label or not stored on the RFID label if it is accessible on the device 10 by other reading means;
an identifier (Electronic Product Code (EPC)) of the serial number of the RFID label 11 stored on the RFID label 11, etc.

The other identifiers (of size that is a multiple of p, for example) may be used in combination with the proprietor code K to generate the initial mark EN₀ so as to render it specific to each device 10 or to each batch of devices, for example. They may be hashed after hashing the proprietor code K.

Of course, these other identifiers must be known to or accessible to the checking system (for example by reading the RFID label or written on the device 10).

The initial mark EN₀ calculated in this way is then stored in the rewritable area Z of the RFID label 11.

It is assumed that the device 10 then begins the succession of treatments EV₁, EV₂, . . . , EVₙ (step F20).

For each treatment EVⱼ (step F30), the scanner 20ⱼ sends the identifier IDⱼ of the treatment to the device 10 by radio (here unencrypted), for example following detection of completion of this treatment by appropriate means known in the art.

This identifier IDⱼ is received by the antenna 11A of the RFID label 11 (step F31) and stored temporarily (and here only) in the calculation volatile memory 11E of the function H.

The calculation means 11C then calculate the current value ENⱼ of the digital traceability mark for the event EVⱼ by applying to the identifier IDⱼ the hashing function H with parameters set by the preceding value ENⱼ₋₁ of the digital mark (step F32):

ENⱼ=H([IDⱼ],ENⱼ₋₁)

The storage means 11D then store the current value ENⱼ in the rewritable area Z by overwriting the value ENⱼ₋₁ of the digital mark calculated for the preceding treatment EVⱼ₋₁ (step F33).

As described above for the proprietor code K, the identifiers IDⱼ (and generally all variables hashed by the hashing function) are deleted from the calculation volatile memory 11E of the RFID chip as soon as they are used by the hashing function, so as to render them inaccessible by reading or interrogating the RFID label.

Following storage of the digital mark ENⱼ, the device 10 is subjected to the next treatment EVⱼ₊₁ (step F40). The steps F31, F32, and F33 are reiterated for each treatment applied to the device 10.

Accordingly, at the end of the succession SEV of treatments applied to the device 10, the traceability mark ENₙ stored in the rewritable area Z represents a condensed history of the ordered treatments EV₁, EV₂, . . . , EVₙ.

It is assumed that the user A next wishes to verify at this stage of the treatment process that the device 10 has experienced a predefined succession SEV_{ref} of n ordered treatments EV_{ref1}, EV_{ref2}, . . . , EV_{refn}. To this end it uses a checking system of one particular embodiment of the invention shown in FIG. 4 and described below.

In the embodiment of the invention described here, the checking system concerned is for example a scanner 30 having the hardware architecture of a computer. It includes in particular a processor 31, a random-access memory (RAM) 32, radio communications means 33 enabling it to communicate with and to read RFID labels (and in particular the RFID label 11 of the device 10), a read-only memory (ROM) 34, and a non-volatile rewritable memory 35.

This memory 35 stores in particular the hashing function H associated with the treatment process PROC, the respective identifiers ID_{refj}, j=1, . . . , n of the treatments of the predefined succession SEV_{ref}, the proprietor code K of the user A, and the public mark e₀. Of course, if an event EV_{refj} from the predefined succession SEV_{ref} corresponds to an event EVⱼ from the succession SEV, the identifiers ID_{refj} and IDⱼ are identical.

The read-only memory (ROM) 34 constitutes a storage medium of the invention storing a computer program of the invention adapted to execute the main steps of the checking method of the invention represented in flowchart form in FIG. 5 and described below.

It should be noted that the checking system 30, the device 10 carrying the RFID chip 11, and the scanners 20ⱼ form a validation system of the invention.

To validate that the device 10 has indeed undergone the predefined succession SEV_{ref} of treatments, the checking system 30 of the invention uses the value of the digital traceability mark ENₙ stored in the device 10 and a theoretical digital mark EN_{ref} representing the predefined succession SEV_{ref} of treatments.

To obtain the value of the digital mark ENₙ stored in the rewritable area Z, the checking system reads the RFID label 11 of the device 10 using its communications means 33 (step G10) in a manner that is known to the person skilled in the art.

What is more, the checking system 30 evaluates the theoretical digital mark EN_{ref} by applying the hashing function H successively to the identifiers ID_{refj}, taken in order, of the events of the succession SEV_{ref} (step G20).

To be more precise, in a first period it evaluates the initial mark EN_{ref,0} using a calculation similar to that used by the device 10 in the step F10 described above to calculate the initial mark EN₀. In other words, here it applies to the proprietor code K the hashing function H with parameters set by the public mark e₀, on the basis of the definitions of K, H, and e₀ stored in its non-volatile memory 35. It should be noted that at this stage:

EN_{ref,0}=EN₀

Then, in a second period, it constructs the theoretical digital mark EN_{ref} iteratively using the equation:

EN_{ref,j}=H([ID_{refj}],EN_{ref,j-1})for J=1, . . . , N

The expected theoretical mark EN_{ref} corresponding to the predefined succession SEV_{ref} of events is given by the last mark value calculated for the event EV_{refn}, in other words EN_{ref}=EN_{ref,n}.

It should be noted that the theoretical mark EN_{ref} may be calculated at any time knowing the identifiers ID_{refj}, the public mark e₀, and the proprietor code K, i.e. “independently” of the moment at which the traceability mark is calculated by the device 10. The theoretical mark EN_{ref} may in particular be pre-calculated.

The checking system 30 then compares the traceability mark ENₙ received from the device 10 with theoretical mark EN_{ref} (step G30).

If the traceability mark ENₙ matches the theoretical mark EN_{ref} (step G40), then the checking system 30 determines that the device 10 has received the predefined succession SEV_{ref} of treatments (step G50).

If not, the checking system 30 deduces from this that the device 10 has not received the predefined succession SEV_{ref} of treatments (step G60). This may be because the order of the treatments has not been complied with or not all the expected treatments have been effected. An additional inquiry and/or correction procedure, not described here, may then be used to find the cause of the problem.

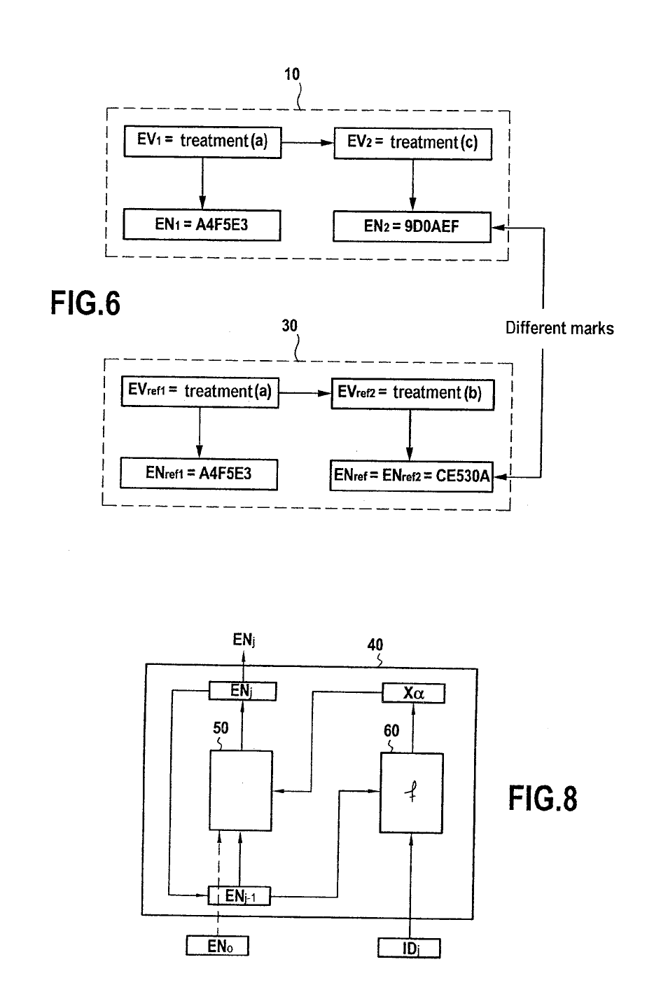

FIG. 6 illustrates an example of digital traceability marks EN₂ and theoretical marks EN_{ref} that are different and respectively generated during the marking and checking processes described above for a number n of treatments equal to 2.

In this example, and in particular for simplicity and clarity, the digital marks are represented in hexadecimal form and are of compact size.

Although the invention applies equally to digital marks that are not necessarily binary and that are of any size, binary digital marks are preferred for reasons of hardware implementation in particular. Moreover, and in particular for reasons of the security and robustness of the hashing function H, the size of the digital marks must be sufficiently large, generally greater than 60 bits.

FIG. 7 represents a device 10 of the invention as described above with reference to FIG. 1 in particular and used in the validation system of a second embodiment of the invention.

In this second embodiment, the scanner 20j′ associated with an event EVⱼ calculates an identifier IDj′ of that event (also referred to as the contextual identifier of the event) from an initial identifier specific to the event. This initial identifier may for example be the identifier IDⱼ considered above in the context of the first embodiment. The contextual identifier IDj′ is an identifier of the event EVⱼ in the sense of the invention.

To calculate the contextual identifier IDj′, in a first period, the scanner 20j′ reads the value of the mark ENⱼ₋₁ on the device 10 in the area Z of the RFID label 11.

In a second period, using appropriate calculation means, it then applies to the initial identifier IDⱼ a cryptographic hashing function h (which is a second hashing function in the context of the invention) with parameters set by the value ENⱼ₋₁, i.e. using the notation introduced above:

IDⱼ′=h([IDⱼ],ENⱼ₋₁)

This hashing function h is for example an SHA-1, SHA-2 or MD5 function. It may be different from the cryptographic hashing function H implemented in the device 10. A different hashing function h may equally be used for each scanner 20ⱼ′.

The identifier IDⱼ′ is then sent to the device 10 (see step F31 in FIG. 3), which calculates from it the current value of the digital traceability mark ENⱼ for the event EVⱼ (see step F32 in FIG. 3), as described above for the first implementation of the invention.

The other steps of the marking method and the checking method of this implementation of the invention are similar to those described for the first implementation. It should be noted that the checking system 30, the device 10 carrying the RFID chip 11, and the scanners 20ⱼ′ form a validation system of the invention.

This second implementation of the invention uses a so-called “reciprocal ignorance” protocol between the device 10 and the scanner 20ⱼ′. This protocol is particularly advantageous, especially in a context in which the event identifier could be intercepted between the scanners and the device could be used dishonestly (for example to counterfeit the process PROC).

In this second implementation of the invention, the scanner 20ⱼ′ cannot obtain access to information concerning the processes previously applied to the device 10 simply by reading the value of the traceability mark ENⱼ₋₁.

Similarly, the device 10 cannot access the initial identifier IDⱼ on the basis of the identifier IDⱼ′ transmitted by the scanner. Given the properties of the cryptographic hashing function h, it is impossible to retrieve the initial identifier IDⱼ from the value ENⱼ₋₁ of the traceability mark and the contextual identifier IDⱼ′.

A similar calculation of the identifiers of the events is implemented in the checking system to enable comparison of marks, of course.

There are described below, with reference to FIG. 8, an example of the hashing function, below referenced H1, and means for calculating that hashing function H1, which can be used in particular by the device 10 (and in particular by the RFID chip 11) and the checking system 30 of the invention. Note that this hashing function H1 may also be used by the scanners 20ⱼ′.

In the example represented in FIG. 8, the hashing function H1 has its parameters set by the value ENⱼ₋₁ of the traceability mark for the event EVⱼ₋₁ (referred to below as the preceding value of the traceability mark), and is applied to the identifier IDⱼ to calculate the value ENⱼ of the traceability mark for the event EVⱼ (below referred to as the current value of the traceability mark).

It is assumed here, for simplicity, that the identifier IDⱼ is of size p and so hashing it requires only one iteration. How to generalize to a plurality of iterations for hashing the identifier IDⱼ is obvious to the person skilled in the art and is not described in detail here.

FIG. 8 represents an iteration effected by means 40 for calculating the hashing function H1, referred to below as iteration j. It should be noted that this figure shows both the main steps of calculating the current value ENⱼ of the digital mark from the identifier IDⱼ and also the means used for this calculation.

The means 40 for calculating the hashing function H1 include a state-vector pseudo-random generator 50 and a preconditioning module 60. The state vector concerned is the traceability mark EN of size t. This traceability mark is assumed binary here, i.e. to comprise t bits.

During iteration j, the pseudo-random generator 50 calculates the current value ENⱼ according to a non-reversible application depending on the preceding value ENⱼ₋₁ and a current intermediate value X_{α} (X_{α} is a vector of size p).

To be more precise, the pseudo-random generator 50 is adapted to apply a predetermined number d of successive permutations of size t1 to a provisional vector of size t1 greater than or equal to t comprising at least one first intermediate vector of size t formed from at least one section of the value ENⱼ₋₁ and the current intermediate value X_{α}. Each permutation is associated with one bit of a permutation key C_{Π} of size d and chosen as a function at least of the value of this bit. The permutation key C_{Π} is obtained from a selection of d bits from the t bits of the first intermediate vector. The current value ENⱼ of the traceability mark is then obtained from at least one section of the result vector of this application step.

The expression “vector Vₐ comprising a vector V_{b}” refers to a vector Vₐ that includes among its components all the components of the vector V_{b} (consecutively or not, in due order or in any order). For example, considering a vector V_{b}=(1, 0, 0, 1) and a vector Vₐ=(0, 1, V_{b}), the vector Vₐ is a vector comprising the vector V_{b} and equal to Vₐ=(0, 1, 1, 0, 0, 1).

Furthermore, a section of a vector of size t refers to a set of j bits of this vector occupying particular positions in the vector, with j between 1 and t inclusive (1≦j≦t). Thus a section of size t of a vector of size t designates the vector itself.

Thus each bit of the permutation key C_{Π}, i.e. each permutation stage, is associated with a permutation P0 if this bit is equal to 0 and a permutation P1 if this bit is equal to 1.

The same pair of permutations (P0, P1) may be considered at the various permutation stages. These permutations P0 and P1 are then preferably defined as different from each other at every point and individually different from the identity permutation at every point.

These assumptions are not in any way limiting on the invention, however, and different pairs of permutations may be considered at each permutation stage, or other conditions may apply to the permutations P0 and P1, for example the condition that the permutation obtained by composition of the permutations P0 and P1 is different at every point from the permutation obtained by composition of the permutations P1 and P0.

It is to be noted that the permutation function Π consisting of the above-mentioned d permutations advantageously constitutes a one-way function, i.e. a function that can be calculated easily in one direction but is difficult or even impossible to reverse within a reasonable time (i.e. with reasonable complexity).

Below this permutation function Π is referred to as having parameters set by the permutation key C_{Π} and the following notation convention is used:

WS=Π(WE,C_{Π})

to denote that the permutation function Π with parameters set by the permutation key C_{Π} is applied to input data WE in order to obtain output data WS.

The current intermediate value X_{α} used by the pseudo-random generator 50 is obtained from a calculation effected by the preconditioning module 60 using a reversible application depending on the preceding value ENⱼ₋₁ and the identifier IDⱼ transmitted by the scanner 20ⱼ.

To be more precise, the preconditioning module 60 applies to the identifier IDⱼ a secret-key symmetrical function ƒ with parameters set by at least one section of the preceding value ENⱼ₋₁ of the traceability mark. This secret-key symmetrical function includes at least one exclusive-OR operation with at least one section of the preceding value ENⱼ₋₁ of the traceability mark.

A hashing function H1 of this particular implementation of the invention is described in detail below with reference to FIG. 9.

In the implementation of the invention described here, the traceability mark EN includes a section X of size p referred to as a state variable. The position of this state variable is predefined and preferably fixed.

In iteration j, the value Xⱼ₋₁ of the state variable X contained in the preceding value ENⱼ₋₁ of the traceability mark is used by the preconditioning module 60 to parameter the secret-key symmetrical function ƒ.

In the example described here, the function ƒ is an exclusive-OR operation executed by the exclusive-OR gate 61 and with parameters set by the value Xⱼ₋₁ (here the secret key of this function ƒ is equal to Xⱼ₋₁).

Thus the exclusive-OR gate 61 calculates the current intermediate value X_{α} by applying an exclusive-OR operation between the identifier IDⱼ and value Xⱼ₋₁ of the state variable X:

X_{α}=IDⱼ⊕Xⱼ₋₁.

Alternatively, the function ƒ may contain other operations (e.g. exclusive-OR operations, permutations, etc.) with parameters set by other sections of the mark ENⱼ₋₁.

The current intermediate value X_{α} is then sent to the pseudo-random generator 50 which evaluates the current value ENⱼ from this current intermediate value and the preceding value ENⱼ₋₁ of the traceability mark.

To this end, first calculation means 51 of the pseudo-random generator replaced the preceding value Xⱼ₋₁ of the state variable X by the current intermediate value X_{α} to form a first intermediate vector Vᵢₙₜ₁ of size t.

Second calculation means 52 then form a provisional vector Vₚᵣₒᵥ of size 2*t from the first intermediate vector Vᵢₙₜ₁ and the complementary vector V̅ᵢ̅ₙ̅ₜ̅₁̅ of this first intermediate vector Vᵢₙₜ₁. As is known in the art, the complementary vector of a vector is obtained from the ones' complement of each bit of that vector.

Here the provisional vector obtained in this way is:

Vₚᵣₒᵥ=( V̅ᵢ̅ₙ̅ₜ̅₁̅Vᵢₙₜ₁)

Alternatively, this provisional vector may be equal to Vᵢₙₜ₁ (i.e. the second calculation means 52 may then be dispensed with) and is then of size t.

The provisional vector Vₚᵣₒᵥ then supplied to third calculation means 53 including permutation means 53b adapted to apply the one-way function Π described above to the provisional vector to form a result vector Vᵣₑₛ.

The one-way function Π applied by permutation means 53b has parameters set by a permutation key C_{Π} of predetermined size d less than or equal to t. Here the choice made is d=t.

The current value of this permutation C_{Π} is formed by formation means 53a from the first intermediate vector. In the example described here, the current value C_{Π} is taken as equal to the value of the first intermediate vector, i.e. C_{Π}=Vᵢₙₜ₁.

Alternatively, in another implementation of the invention, the size of the key d may be strictly less than t. The permutation key C_{Π} is then formed by the means 53a selecting d distinct bits, consecutive or not, from the t bits of the first intermediate vector Vᵢₙₜ₁, the positions of the selected d bits preferably being pre-established and fixed. The size d of the permutation key is preferably made greater than the size of the current intermediate value X_{α} (d≧p) and the selected d bits preferably include the current intermediate value X_{α}.

Thus here the one-way function Π applied by the permutation means 53b results from applying d=t successive permutations of size t1=2*t, each permutation being associated with a different bit of the permutation key C_{Π}=Vᵢₙₜ₁ and being chosen as a function at least of the value of this bit (contained for example in a predefined permutation table). Alternatively it may depend equally on the permutation stage concerned.

The result vector Vᵣₑₛ obtained at the end of this application step is of size t1=2*t.

The pseudo-random generator 50 further includes fourth calculation means 54 that select a section of t bits from the t1 bits of the result vector Vᵣₑₛ to form a second intermediate vector Vᵢₙₜ₂. For example, the second intermediate vector Vᵢₙₜ₂ is formed by the first t bits of the result vector Vᵣₑₛ.

The pseudo-random generator 1 also includes fifth calculation means 55 including an exclusive-OR gate 55a combining the preceding value ENⱼ₋₁ of the traceability mark and the second intermediate vector Vᵢₙₜ₂ to form the current value ENⱼ of the traceability mark.

Note that hardware implementation of this hashing function has the advantage of being of very small overall size. It is possible in particular to implement this function on a passive RFID chip with very few logic gates.

Moreover, the proposed hashing function may advantageously be applied to words of any predetermined size before it is used to generate marks of any size predetermined before it is implemented.

The marking method of the invention may make it possible to use hybrid traceability solutions that also use a centralized information system as described above with reference to the prior art techniques.

It is envisaged here, for example, that this centralized information system includes at least one computer server connected to a computer network and to which scanners are connected for each tracked treatment step applied to a device to be tracked equipped with an RFID label. These scanners are responsible for collecting and sending to this server via the computer network the information read on the RFID label of the device to be tracked. It is furthermore assumed that this information system includes means enabling it to implement a checking system of the invention.

The device to be tracked conforms to the invention. Below the expression traceability module combines the means of the device for obtaining an identifier of the event, the means of the device for calculating the traceability mark, and the means of the device for storing the traceability mark. This traceability module is included in the RFID chip of the device to be tracked, for example. Here it also includes an identifier that can be used by the centralized information system (for example an identifier of the device).

In the example described here, the device to be tracked further includes means for activating and deactivating the traceability module. As a result, the traceability module may advantageously take over from the centralized information system (i.e. be activated) for events that the device to be tracked undergoes in areas far from or not connected to the centralized information system. It is assumed that these areas are provided with autonomous scanners compatible with the traceability module so as to be able to implement the marking method of the invention.

The traceability module communicates the traceability mark and the identifier of the device to the centralized information system when the device to be tracked returns to areas covered by the centralized information system. As a result, the information system can update a central database containing all events experienced by the device (after interpreting the mark using a checking method of the invention) for subsequent general validation (including validation of events monitored by the centralized information system and events that are not monitored).

The traceability module is deactivated when the device can again be monitored by the central information system (for example on reception of a predefined message from the information system).

This solution thus makes it possible to deploy extremely flexible traceability architectures and likewise to guarantee traceability of an object or a product in sectors that are not connected to the centralized information system for technical or economic reasons.

This solution may also be used in the event of failure of the centralized information system, the device taking over from the information system until the information system returns to normal.

In the examples described above, a treatment process is considered aiming to apply to a device such as an object or a product a predetermined number M of treatments (events in the sense of the invention).

Alternatively, the invention applies equally to other types of events, for example a state or change of state of a physical parameter of a device (e.g. temperature, pressure, etc.) during a single-variable process or a multivariable process (e.g. traceability of a plurality of physical parameters). For example, it can be implemented by defining acceptance ranges of each of the tracked parameters for the entire duration of the process.

The various events considered then correspond to predetermined times at which the value of each tracked parameter is measured. This value may be measured directly by the traceability module (e.g. when incorporated in a passive or active RFID label).

These values are then integrated into calculating the traceability mark as identifiers of the events in the sense of the invention, for example in accordance with principles identical to those described above with reference to the first implementation. Thus the digital traceability mark carried by the device is different from the expected theoretical mark if a measured value differs from an accepted range of values (i.e. event from a predefined succession in the sense of the invention).

The invention thus has multiple applications including:
traceability in distribution networks, in particular to combat parallel markets and infringement;
traceability of parameters, for tracking physical cycles with parameters;
traceability of fabrication and inspection steps;
equipment maintenance and servicing, etc.

1. A method of validating a succession of events in the life of a device (10) relative to a predefined succession of events, said method being characterized in that it includes:
for each event (EVⱼ) of said succession experienced by the device:
a step (F32) of calculating a current value of a traceability mark by applying to an identifier (IDⱼ) of the event a cryptographic hashing function (H) with parameters set by the value of the traceability mark calculated for the preceding event;
a step (F33) of storing this current value on the device;
after the succession of events, a step (G10) of a checking system obtaining the latest value of the traceability mark stored on the device;
a step (G20) of this checking system generating the value of a theoretical mark by applying the hashing function successively to identifiers taken in the order of the events of the predefined succession; and
if the latest value of the traceability mark is equal to the value of the theoretical mark (G30, G40), a step (G50) of validating that the predefined succession of events has been experienced by the device.

2. A validation method according to claim 1, wherein said identifier is managed by a module (20ⱼ) external to the device and associated with the event (20ⱼ).

3. A validation method according to claim 1, wherein said method further includes, for each event, before the calculation step (F32):
a step of a module (20ⱼ) associated with the event obtaining the value of the traceability mark calculated for the preceding event stored on the device; and a step of said module calculating the identifier of this event by applying to an initial identifier of this event a second hashing function with parameters set by this value.

4. A system for validating a succession of events in the life of a device (10) relative to a predefined succession of events, said system being characterized in that it includes:
means (11A) for obtaining an identifier of each event of the succession;
calculation means (11C) for calculating for each event (EVE) of said succession a current value of a traceability mark by applying to the identifier of the event a cryptographic hashing function with parameters set by the value of the traceability mark calculated for the preceding event; and
storage means (11D) for storing this current value on the device;
a checking system (30) including:
means (33) for obtaining the latest value of the traceability mark stored on the device after the succession of events;
means (31) for generating a value of a theoretical mark by applying the hashing function successively to identifiers taken in the order of the events of the predefined succession; and
means (31) for validating that the predefined succession of events has been experienced by the device if the latest value of the traceability mark is equal to the value of the theoretical mark.

5. A validation system according to claim 4, wherein said identifier is managed by a module (20ⱼ) external to the device and associated with the event (20ⱼ).

6. A validation system according to claim 4, wherein said validation system further includes a module (20j) associated with each event of the succession and including:
means for obtaining from the device the value of the traceability mark calculated for the preceding event; and
calculation means for calculating the identifier of this event by applying to an initial identifier of this event a second cryptographic hashing function with parameters set by this value.

7. A validation system according to claim 4, wherein the means for obtaining an identifier of each event of the succession, the calculation means, and the storage means are implemented on the device.

8. A validation system according to claim 4, wherein the means for obtaining an identifier of each event of the succession, the calculation means, and the storage means are implemented on a RFID chip (11) carried by the device.

9. A validation system according to claims 4, wherein the storage means store the current value of the traceability mark on the device by replacing the value of the traceability mark stored for the preceding event.

10. A checking method for determining whether a predefined succession of events has been experienced by a device, characterized in that it comprises:
a step (G10) of obtaining a value of a traceability mark stored on the device;
a step (G20) of generating a value of a theoretical mark by applying a cryptographic hashing function successively to identifiers taken in order of the events of the predefined succession; and
a step (G50) of validating that the predefined succession of events has been experienced by the device if the value of the traceability mark is equal to the value of the theoretical mark.

11. A checking system (30) adapted to determine whether a predefined succession of treatments of events has been experienced by a device, wherein the system includes:
means for obtaining a value of a traceability mark stored on the device;
means for generating a value of a theoretical mark by applying a cryptographic hashing function successively to identifiers taken in order of the events of the predefined succession;
means for comparing the value of the traceability mark with the value of the theoretical mark; and
means for determining that the predefined succession of events has been experienced by the device if the value of the traceability mark is equal to the value of the theoretical mark.

12. A computer program including instructions for executing the steps of the checking method according to claim 10 when it is executed by a computer.

13. A computer-readable storage medium storing a computer program including instructions for executing the steps of the checking method according to claim 10.

14. A method of marking a device, wherein the method includes, for each event of a succession of events experienced by the device:
a step (F31) of obtaining an identifier of this event;
a step (F32) of calculating a current value of a traceability mark by applying to the identifier of this event a cryptographic hashing function with parameters set by the value of the traceability mark calculated for the preceding event; and
a step (F33) of storing this current value on the device.

15. A calculation device (10) that includes:
means for obtaining an identifier of each event of a succession of events in the life of the device;
calculation means for calculating for each event of the succession a current value of a traceability mark by applying to the identifier of the event a cryptographic hashing function with parameters set by the value of the traceability mark calculated for a preceding event; and
storage means for storing this current value.

16. An RFID chip (11) adapted to be mounted on a device (10), wherein said RFIF chip (11) includes:
means for obtaining an identifier of each event of a succession of events in the life of the device;
calculation means for calculating for each event of the succession a current value of a traceability mark by applying to the identifier of the event a cryptographic hashing function with parameters set by the value of the traceability mark calculated for a preceding event; and
storage means for storing this current value.

17. An RFID chip (11) according to claim 16, wherein said RFID chip (11) further includes:
means (11A) for receiving a proprietor code (K); and
means for protecting this code adapted to render it inaccessible to an unauthorized third party by reading said chip; and
said calculation means are further adapted to calculate an initial value of the traceability mark by applying said hashing function to at least said proprietor code.
